(19) United States
(12) Patent Application Publication
(10) Pub. No.: US 2016/0250902 A1
(43) Pub. Date: Sep. 1, 2016

(54) DEVICE FOR CONTROLLING THE PRESSURE IN A VEHICLE TYRE

(71) Applicant: PRESSURERITE (PTY) LTD, Cape Town (ZA)

(72) Inventor: Pierre Van Wyk BECKER, Montague Gardens, Western Cape (ZA)

(21) Appl. No.: 15/032,317

(22) PCT Filed: Oct. 28, 2014
(86) PCT No.: PCT/IB2014/065656

§ 371 Date: Apr. 27, 2016

(30) Foreign Application Priority Data
Oct. 28, 2013 (ZA) 2013/08037

(51) Int. Cl. B60C 23/00; F04B 35/06; F04B 35/01; F04B 53/16; F04B 53/14; F04B 49/02; B60C 23/12; F04B 39/12

(52) U.S. Cl. CPC B60C 23/004; B60C 23/12; F04B 35/06; F04B 39/125; F04B 53/16; F04B 53/14; F04B 49/02; F04B 35/01

(57) ABSTRACT

A device 10 for providing air to a tyre which is mounted on a rim (16) which itself is free to rotate about a fixed, that is, non-rotatable axle (22). A pump is provided which in use rotates with the tyre and which is configured to provide, when activated, air under pressure to the tyre. The pump drive system for activating the pump upon a loss of air pressure in the tyre consists of a first part that is rotationally connected to the tyre and a second part which includes a first clutch plate (42) which rotates with the first part whilst the pump is not activated. The pump is activated by inhibiting the second part of the drive system from rotating with the first part. Relative rotation between the first and second parts drives the pump to provide air under pressure to the tyre. There is a second clutch plate (26) which is configured so that it can be attached to the fixed axle (22) so that it itself is fixed, that is, non-rotatable. The first and second clutch plates (26, 42) are normally spaced apart. A clutch piston, moved by pressure in the tyre, engages the clutch by urging the first clutch plate (42) against the second clutch plate (26) upon the pressure in the tyre dropping below a predetermined value.

### FIELD OF THE INVENTION

This invention relates to self-contained devices for maintaining pressure in rotating elements, such as vehicle tyres.

### BACKGROUND TO THE INVENTION

Devices for maintaining vehicle tyre pressure are disclosed in U.S. Pat. No. 7,013,931 and PCT/IB2013/054732 (published as WO2014/009822. The devices are attached to vehicle wheels and each includes a hanging, stationary counterweight, while the remainder of the device normally rotates with the wheel. When a tyre on the vehicle wheel loses pressure, a part of the device becomes connected to the counterweight, so that it becomes stationary. Relative motion between the part that is stationary and the remainder of the device is used to drive a pump that pressurises the tyre to the desired pressure.

The present invention seeks to provide a simple and cost-effective improvement on such prior devices.

### SUMMARY OF THE INVENTION

According to the present invent there is provided a device for providing air to a tyre which is mounted on a rim which itself is free to rotate about a fixed, that is, non-rotatable axle, the device comprising:—
a) a pump which in use rotates with the tyre and which is configured to provide, when activated, air under pressure to the tyre:—
b) a pump drive system for activating the pump upon a loss of air pressure in the tyre, the pump drive system comprising:—
   b1) a first part that is rotationally connected to the tyre;
   b2) a second part which includes a first clutch plate and which rotates with the first part whilst the pump is not activated, the pump being activated by inhibiting the second part from rotating with the first part, relative rotation between the first and second parts driving the pump to provide air under pressure to the tyre;
c) a second clutch plate which is configured so that it can be attached to said fixed axle so that it itself is fixed, that is, non-rotatable, the first and second clutch plates normally being spaced apart;
d) a clutch piston, moved by pressure in the tyre, for engaging the clutch by urging the first clutch plate against the second clutch plate, upon the pressure in the tyre dropping below a predetermined value, whereby rotation of said second part with respect to the first part is inhibited and the pump is activated.

Said second clutch plate preferably includes a threaded bore to enable it to be screwed onto the threaded end of the fixed axle.

In one form of the device a non-rotatable pump axle having a shaft and an enlarged head is provided, the second clutch plate having a central opening through which the pump axle shaft, but not the head, can pass, the second clutch plate, in use, trapping the pump axle head between itself and the fixed axle.

Drive for the pump can be obtained by using an eccentric body which is mounted, by way of bearings, on said pump axle, the eccentric body being integral with the first clutch plate.

### BRIEF DESCRIPTION OF THE DRAWINGS

For a better understanding of the present invention, and to show how the same may be carried into effect, the invention will now be described by way of non-limiting example, with reference to the accompanying drawings in which:

FIG. 1 is a perspective view of a pair of vehicle wheels, with a device according to the present invention fitted on a hub of the wheels;

FIG. 2 is a sectional view of the pair of wheels and device of FIG. 1; and

FIG. 3 is a sectional view of the device of FIGS. 1 and 2 to a larger scale.

### DETAILED DESCRIPTION OF THE DRAWINGS

Referring to the drawings, a device according to the present invention is generally indicated by reference numeral 10 and is shown in its “in use” position in which it provides fluid in the form of compressed air to a rotating element in the form of a pneumatic tyre.

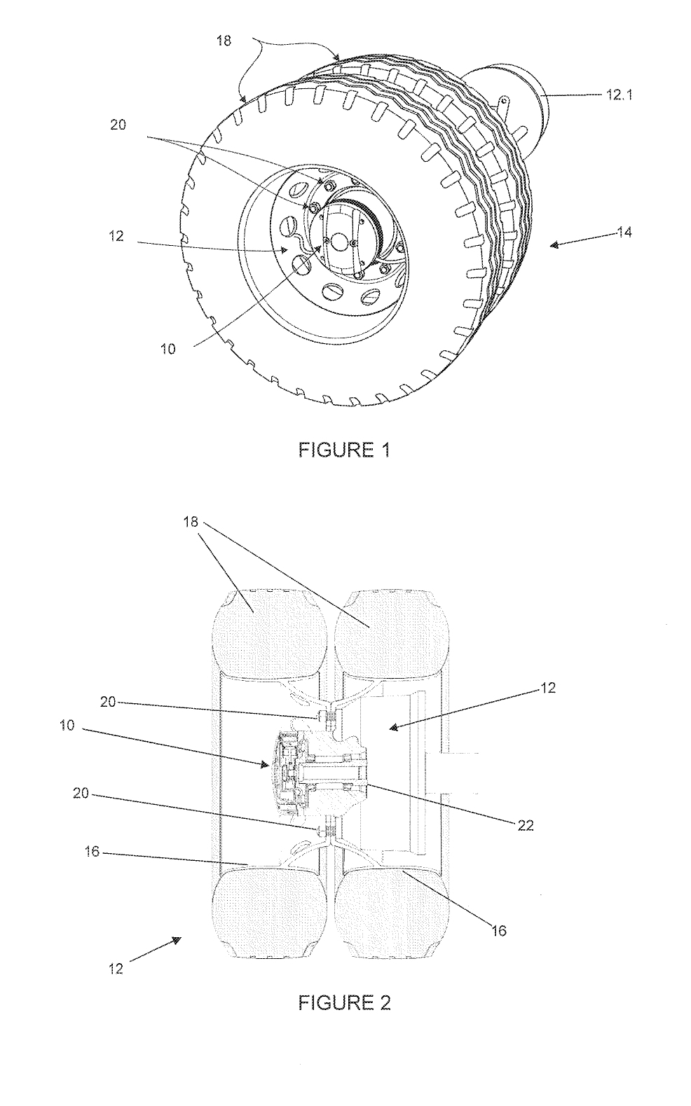

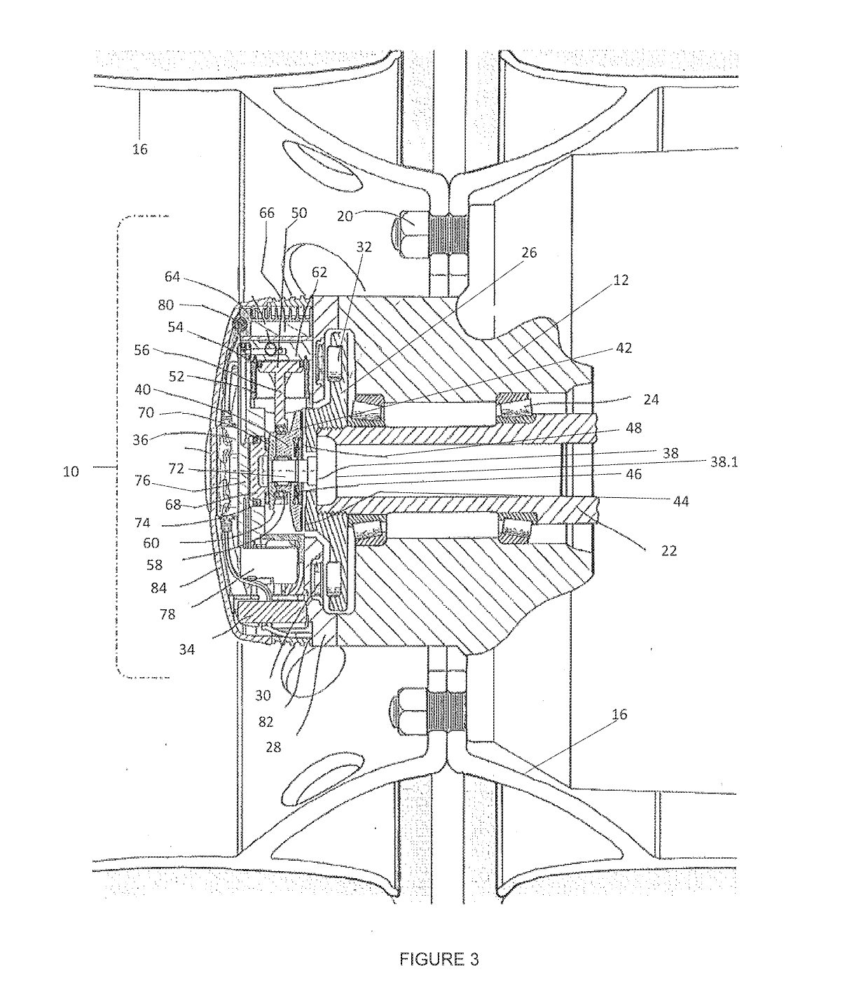

The device 10 is integrated into the hub 12 of a pair of wheels 14. Each wheel 14 comprises a rim 16 with a pneumatic tyre 18 on it, the rims 16 being attached to the hub 12 by wheel nuts 20. In the illustrated example, the wheels are not driven e.g. they are for a heavy vehicle trailer. In FIG. 1, another hub 12.1 is shown which shares a common stationary hollow axle 22 (FIGS. 2 and 3) with the hub 12.

Referring now to FIG. 3, the hub 12 is rotationally supported on the stationary hollow axle 22 by a pair of wheel bearings 24. The end of the axle 22 is threaded and a clutch plate 26 is attached to its screw thread, thereby retaining the hub 12 and the wheel bearings 24 in place on the axle 22. In preferred embodiments, the clutch plate 26 is attached to the axle 22 using additional attachment means, to keep it secure, ensure correct axial orientation, etc. By virtue of its attachment to the axle 22, the clutch plate 26 does not rotate with the hub 12 and is thus a stationary object.

A main plate 28 is attached to the hub 12 adjacent the outer circumference of the clutch plate 26. A plurality of alternator coils 30 are carried by the main plate 28, on the same radius as a plurality of alternator magnets 32 that are carried by the clutch plate 26. When the hub 12 and wheels 14 rotate, the main plate 28 rotates with them and movement of the alternator coils 30 in close proximity to the magnets 32 induces current in the coils, which is used to charge a battery pack 34 and provide power to electronics 36 of the device 10. The main plate 28 has a central aperture through which a part of the clutch plate 26 extends.

A pump axle 38 is located at the end of the axle 22 and a head 38.1 of the pump axle 38 is held in position in a recess at the end of the axle 22 by the clutch plate 26. The pump axle 38 extends outwards relative to the wheels i.e. to the left as shown in FIGS. 2 and 3 from the clutch plate 26 and remains stationary, with the axle 22 and the clutch plate 26. An eccentric body 40 is supported on the pump axle 38 to rotate about the pump axle 38 on roller bearings 42. The body also forms a second clutch plate 42 faced with friction material 44. The second clutch plate 42 rotates relative to the clutch plate 26. The clutch plates 26, 42 are normally kept apart by a Bellville spring washer 46. There is a thrust roller bearing 48 between the Bellville washer 46 and the plate 26. The clutch plate 26 and the second clutch plate 42 form a clutch that is engaged when the eccentric body 40, and hence the second clutch plate 42, slides inwards (to the right) on the pump axle 38 so that the friction material 44 grips the part of the clutch plate 26 protruding through the aperture in the main plate 28.

The device 10 further includes a pump piston 50 that can reciprocate in a pump cylinder sleeve 52 with a pump piston seal 54 sealing between the pump piston 50 and the sleeve 52. The piston 50 is connected to the eccentric 40 by a connecting rod 56, running on a big end bearing 58 that is held in place by an eccentric bearing plate 60. A compression chamber is formed between the piston 50, sleeve 52 and a cylinder head 62 that includes an air filter 64 with a foam filter element 66. The piston 50, cylinder sleeve 52, seal 54, cylinder head 62, etc. form a pump that is configured to provide compressed air to the tyres 18. The connecting rod 56 of the pump piston 50 forms a first part of a pump drive system and the eccentric 40 forms a second part of the pump drive system. The pump drive system is configured to activate the pump when pressure in a tyre 18 drops below a predetermined threshold, as will be described below.

A clutch piston 68 is provided on the outside of the eccentric bearing plate 60 with a thrust roller bearing 70 between them. A cavity 72 is formed on the outside of the clutch piston 68 and is sealed around the circumference of the clutch piston by a clutch piston seal 74.

A pressure manifold 76 is attached to the outside of the clutch piston 68 and the pump. The manifold 76 defines a number of flow passages, connectors, etc. Three solenoid operated pneumatic valves 78, only one of which can be seen, are provided which are controlled by the electronics 36. The operation of the pressure manifold 76 is substantially as described in more detail in PCT/IB2013/054732 and as will be evident from its functional description below. Suffice it to say that it defines a cavity adjacent the clutch piston 68 and connects two tyre pressure hoses (from the two tyres 18), solenoid valves 78, two Schrader inflation valves and a pressure port from the compression chamber of the pump to a common cavity within the manifold.

Some of the ancillary features that are shown in FIG. 3 include an antenna 80 which allows the electronics 36 to communicate with external devices (e.g. with the vehicle's on-board computer); and wheel temperature and rotational speed sensors 82. Rotational speed is determined through a Hall effect sensor that senses rotation of a magnet attached to the clutch plate 26. The parts of the device 10 on the outside of the main plate 28 (apart from the Schrader inflation valves) are protected by a cover 84.

In use, the entire device 10 normally rotates with the wheel hub 12, apart from the clutch plate 26. When tyre pressure in a tyre 18 drops below a predetermined pressure, air pressure from that tyre is directed via the manifold 76 and solenoid valves 78 to the cavity 72 on the outside of the clutch piston 68 and the pressure urges the clutch piston 68 inwards, which presses the eccentric body 40, via the thrust roller bearing 58 and eccentric bearing plate 60, inwards against the bias of the Bellville spring washer 48 until the friction material 44 makes contact with the clutch plate 26 to engage the clutch. When this happens, the eccentric body 40 no longer rotates with the wheel hub 12, but it is inhibited from rotation by its frictional connection to the stationary clutch plate 26.

While the eccentric 40 is held stationary against the clutch plate 26, the remainder of the device 10 continues its rotation and the relative rotation between the big end of the connecting rod 56 and the eccentric body 40 causes the connecting rod 56 and pump piston 50 to reciprocate within the pump cylinder sleeve 52. The pump is thus activated and supplies compressed air that is directed via the pressure manifold 76 to the tyre 18.

When the tyre pressure reaches a predetermined level, the tyre pressure is disconnected by the manifold 76 and solenoid valves 78 from the cavity 72 of the clutch piston 68 and the clutch piston cavity is vented to atmosphere, so that the pressure holding the clutch in engagement is released and the Bellville spring washer 48 urges the second clutch plate 42, which is integrally formed with the eccentric body 40, and the clutch plate 26 apart. The device 10 thus returns to its normal state and the entire device continues to rotate with the wheel hub 12, apart from the clutch plate 26.

1. A device for providing air to a tyre which is mounted on a rim which itself is free to rotate about a fixed, that is, non-rotatable axle, the device comprising:—
a) a pump which in use rotates with the tyre and which is configured to provide, when activated, air under pressure to the tyre:—
b) a pump drive system for activating the pump upon a loss of air pressure in the tyre, the pump drive system comprising:—
b1) a first part that is rotationally connected to the tyre;
b2) a second part which includes a first clutch plate and which rotates with the first part whilst the pump is not activated, the pump being activated by inhibiting the second part from rotating with the first part, relative rotation between the first and second parts driving the pump to provide air under pressure to the tyre;
c) a second clutch plate which is configured so that it can be attached to said fixed axle so that it itself is fixed, that is, non-rotatable, the first and second clutch plates normally being spaced apart;
d) a clutch piston, moved by pressure in the tyre, for engaging the clutch by urging the first clutch plate against the second clutch plate, upon the pressure in the tyre dropping below a predetermined value, whereby rotation of said second part with respect to the first part is inhibited and the pump is activated.

2. A device as claimed in claim 1, wherein said second clutch plate includes a threaded bore to enable it to be screwed onto the threaded end of the fixed axle.

3. A device as claimed in claim 1, and including a non-rotatable pump axle having a shaft and an enlarged head, the second clutch plate having a central opening through which the pump axle shaft, but not the head, can pass, the second clutch plate, in use, trapping the pump axle head between itself and the fixed axle.

4. A device as claimed in claim 3, and including an eccentric body which is mounted, by way of bearings, on said pump axle, the eccentric body being integral with the first clutch plate.

5. A device as claimed in claim 2, and including a non-rotatable pump axle having a shaft and an enlarged head, the second clutch plate having a central opening through which the pump axle shaft, but not the head, can pass, the second clutch plate, in use, trapping the pump axle head between itself and the fixed axle.
